(19) United States
(12) Patent Application Publication
(10) Pub. No.: US 2005/0249073 A1
(43) Pub. Date: Nov. 10, 2005

(54) Information processing device, disc unit, information processing method, information processing program and recording medium containing the program

(75) Inventor: Takaaki Ujiie, Kawagoe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/092,974

(22) Filed: Mar. 30, 2005

(30) Foreign Application Priority Data
Mar. 30, 2004 (JP) 2004-099972

(51) Int. Cl. G11B 5/09

(52) U.S. Cl. 369/47.36; 369/47.1; 369/47.38

(57) ABSTRACT

At the time when an optical disc 10 is attached, a system controller 300 allows an optical pickup 220 to perform focus search and thereby recognizes the type of the optical disc 10 and, at the same time, rotates a spindle motor 212 at a constant linear velocity at the position at which the optical pickup reads the information. During the constant linear velocity control, the system controller 300 recognizes the position of the optical pickup 220 based on a count value of an internal counter, distance r between the recognized position and the center of the optical disc 10, and rotation speed N. Based on the recognized information, the system controller 300 calculates the specific linear velocity L of the optical disc 10 according to the relational expression: L=2πrN. An actual predetermined position at which information processing is performed is calculated in a relative way based on the specific linear velocity. At the time when information processing is performed, it is possible to adequately move the optical pickup 220 to the actual information processing position, thereby reducing the time to start information processing and resulting in speedy information processing.

### BACKGROUND OF THE INVENTION

1. Field of the Invention

The present invention relates to an information processing device which performs at least one of a process of reading information recorded on the recording surface of a recording medium and a process of recording the information onto the recording surface, its method, its program, a recording medium containing the program, and a disc unit.

2. Description of Related Art

It has been desired to reduce the time required to start an information processing operation for a disc recording medium in a disc unit which reads information from a disc recording medium such as an optical disc or records information in the medium, and a configuration that reduces the time for setting-up is known (see, for example, Jpn. Pat. Laid-Open Publication No. 2001-332011, right column of page 3 to left column of page 12).

The configuration disclosed in the above publication sets up a new disc according to the reproduction parameter of CD-DA, and, when correct focus cannot be obtained, it changes the amplification factor of an OEIC and focus gain based on predetermined condition. Alternatively, it consecutively performs focus search with the reproduction parameter of CD-DA as the reproduction parameter of DVD 7 and sets reproduction parameter suitable for DVD reproduction at the time when correct focus is obtained. That is, a configuration in which the reproduction parameter that has previously been set is used to perform a set-up operation in a consecutive manner in order to set-up the reproduction parameter of DVD has been adopted.

Here, assume that two CDs of the same type are reproduced in the case where correct focus can be obtained in both the CDs in a conventional configuration as described in the above publication. In this case, even when the same information has been recorded on the respective CDs, if the information has been recorded with different linear velocities, recorded positions of the information differ between the two. Accordingly, when an optical pickup is moved by the same distance in order to reproduce the same information, the desired information on one CD can be reproduced; whereas the same information on other CD cannot be read, and therefore the information is searched again and the optical pickup is moved to the position at which the desired information has been recorded. As described in the above example, it has been desired to reduce the time to start information processing such as reproduction.

### SUMMARY OF THE INVENTION

A main of the present invention is to provide an information processing device capable of performing information processing satisfactorily, its method, its program, a recording medium containing the program, and a disc unit.

According to a first aspect of the present invention, there is provided an information processing device that allows a drive section to rotate a disc recording medium and allows an information processing section which is moved, by a moving section, along the recording surface of the disc recording medium in the radial direction thereof to perform at least one of a process of reading information recorded on the disc recording medium and a process of recording the information onto the disc recording medium, including: a drive control section that controls the drive section at linear velocity corresponding to the type of the disc recording medium to allow the information processing section to read information recorded at an arbitrary position on the disc recording medium; a rotation speed detection section that detects the rotation speed of the disc recording medium at the time when the drive section is controlled at a constant linear velocity by the drive control section; a distance recognition section that recognizes the position of the information processing section and thereby recognizes the distance between the center of the disc recording medium and the position at which the information processing section reads the information; and a movement distance control section that calculates the linear velocity of the disc recording medium based on the rotation speed and the distance, calculates the distance between a predetermined position of the information to be processed on the disc recording medium and the center thereof based on the linear velocity, and controls the moving section based on the calculated distance to move the information processing section to the predetermined position.

According to a second aspect of the present invention, there is provided a disc unit including: a drive section that rotates a disc recording medium; an information processing section that performs at least one of a process of reading information recorded on the disc recording medium and a process of recording the information onto the disc recording medium; a moving section that moves the information processing section along the recording surface of the disc recording medium in the radial direction thereof; and the abovementioned information processing device according to the present invention.

According to a third aspect of the present invention, there is provided a disc unit including: a drive section that rotates a disc recording medium at a constant linear velocity; an information processing section that performs at least one of a process of reading information recorded on the disc recording medium and a process of recording the information onto the disc recording medium; a moving section that moves the information processing section along the recording surface of the disc recording medium in the radial direction thereof; and a controller that detects the distance between the information that the information processing section reads on the disc recording medium and the center thereof and the rotation speed of the disc recording medium to thereby calculate the linear velocity of the disc recording medium, and calculates, based on the calculated linear velocity, the distance between a predetermined information on the disc recording medium and the center thereof to thereby control the moving section to move the information processing section.

According to a fourth aspect of the present invention, there is provided an information processing method that rotates a disc recording medium and moves an information processing section along the recording surface of the disc recording medium in the radial direction thereof to thereby perform at least one of a process of reading information recorded on the disc recording medium and a process of recording the information onto the disc recording medium, including the steps of: allowing the information processing section to read information described at an arbitrary position on the disc recording medium to rotate the disc recording medium at a constant linear velocity; recognizing the rotation speed of the disc recording medium at the time of the constant linear velocity control and the distance between the position at which the information processing section reads the information and the center of the disc recording medium; calculating the linear velocity of the disc recording medium at the position where the information processing section is reading the information based on the recognized rotation speed and the distance; recognizing a predetermined position of the information to be processed on the recording medium in response to a request for the information processing and recognizing the distance between the predetermined position on the disc recording medium and the center thereof based on the calculated linear velocity; and moving the information processing section to the predetermined position based on the recognized distance.

According to a fifth aspect of the present invention, there is provided an information processing method that rotates a disc recording medium and moves an information processing section along the recording surface of the disc recording medium in the radial direction thereof to thereby perform at least one of a process of reading information recorded on the disc recording medium and a process of recording the information onto the disc recording medium, including the steps of: controlling the drive section at linear velocity corresponding to the type of the disc recording medium to allow the information processing section to read information recorded at an arbitrary position on the disc recording medium; detecting the rotation speed of the disc recording medium at the time when the drive section is controlled at a constant linear velocity and recognizing, based on the position of the information processing section, the distance between the center of the disc recording medium and the position at which the information processing section reads the information; calculating, based on the rotation speed and the distance, the linear velocity of the disc recording medium at the position where the information processing section reads the information; calculating, based on the calculated linear velocity, the distance between a predetermined position of the information to be processed on the disc recording medium and the center thereof; and controlling the moving section based on the calculated distance to move the information processing section to the predetermined position.

According to a sixth aspect of the present invention, there is provided a recording medium on which an information processing program allowing a computer to function as the abovementioned information processing device according to the present invention is recorded in a computer readable manner.

According to a seventh aspect of the present invention, there is provided a recording medium on which an information processing program allowing a computer to execute the abovementioned information processing method according to the present invention is recorded in a computer readable manner.

### BRIEF DESCRIPTION OF THE DRAWINGS

FIG. 1 is a block diagram schematically showing the configuration of a disc unit according to an embodiment of the present invention;

FIG. 2 is a partly cutaway plan view showing the vicinity of a disc processing section in the embodiment;

FIG. 3 is a block diagram schematically showing the configuration of a system controller in the embodiment;

FIG. 4 is an explanatory view to help explain the moving state of an optical pickup in the embodiment; and

FIG. 5 is an illustration explaining how a linear velocity is measured in the embodiment.

### DETAILED DESCRIPTION OF THE PREFERRED EMBODIMENTS

An embodiment of the present invention will be described below with reference to the accompanying drawings.

Though in the embodiment, a disc unit that records and reads information on/from a detachable optical disc recording medium is taken as an example, the disc unit may perform only one of the information reading and recording operations. Also, the disc recording medium is not limited to the optical disc, but can be any disc recording medium such as a magnetic disc, a magneto optical disc. The disc unit is not limited to a disc unit for use in a car-mounted reproduction unit, but any configuration including, for example, one called “Slim Drive” in which an optical pickup is provided integrally with a tray to be fitted to an electrical apparatus such as a portable personal computer, one having a tray that conveys an optical disc, one called “Slot in Type” in which a conveyance tray is not provided, or the like can be employed. Further, a stand-alone disc unit such as a game machine or reproduction unit that records or reproduces video data and like can be employed.

[Configuration of Disc Unit]

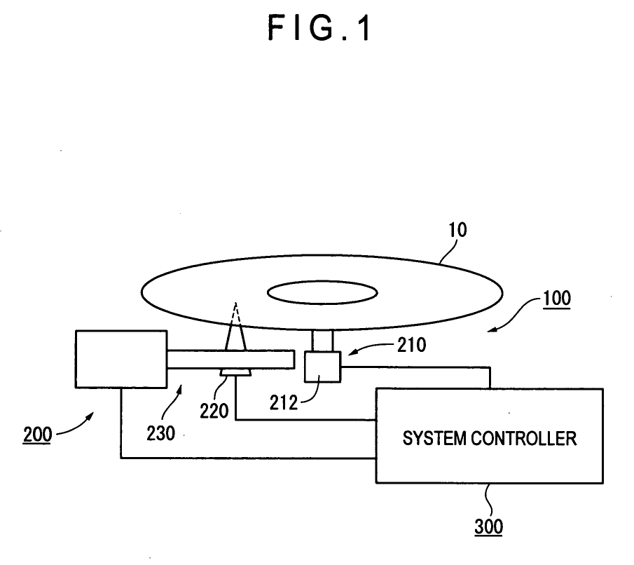

In FIG. 1, a disc unit 100 is, for example, a car-mounted reproduction unit. The disc unit 100 performs a reading process which is information processing of reading out information recorded on a recording surface (not shown) formed at least on one surface of a disc-shaped optical disc 10 serving as a disc recording medium detachably attached to the disc unit 100 and a recording process which is another information processing of recording various information onto the recording surface. The disc unit 100 has substantially a box-shaped hollow case body (not shown) made of metal, and an opening portion which opens in a slit is formed on the front surface of the case body. Provided within the case body are a disc processing section 200 which performs the information processing, a conveyance section (not shown), and a system controller 300 which is an information processing device serving both as a calculation section and controller to control the entire operation of the disc unit 100.

The disc processing section 200 includes a drive section 210 for rotating the optical disc 10, an optical pickup 220 serving as an information processing section, and a moving section 230 for moving the optical disc 10 along the recording surface of the optical disc 10 in the radial direction thereof. Under the control of the system controller 300, the disc processing section 200 rotates the optical disc 10 with a constant linear velocity by the drive section 210 and appropriately moves the optical pickup 220 along the recording surface of the rotating optical disc 10 by the moving section 230, to thereby allow the optical pickup 220 to read out information recorded on the recording surface and to record information onto the recording surface.

The conveyance section conveys the optical disc 10 to the inside or outside of the case body through the opening portion. The conveyance section is connected to the system controller 300. When detecting that a part of the optical disc 10 is inserted into the opening portion, the system controller 300 allows the conveyance section to rotate, for example, a roller (not shown) to convey the optical disc 10 toward the inside of the case body, up to the position where the disc processing section 200 can apply predetermined processing thereto. Further, when recognizing a signal requesting the eject of the optical disc 10 that has been attached to the inside of the case body (for example, a signal issued by the operation of an eject button), the system controller 300 allows the conveyance section to rotate a roller (not shown) or the like to convey the optical disc 10 that has been held in the position where the predetermined processing can be applied to the optical disc 10 by the disc processing section 200 to the outside of the case body through the opening portion.

(Configuration of Disc Processing Section)

A detailed configuration of the disc processing section 200 will next be described with reference to the drawings.

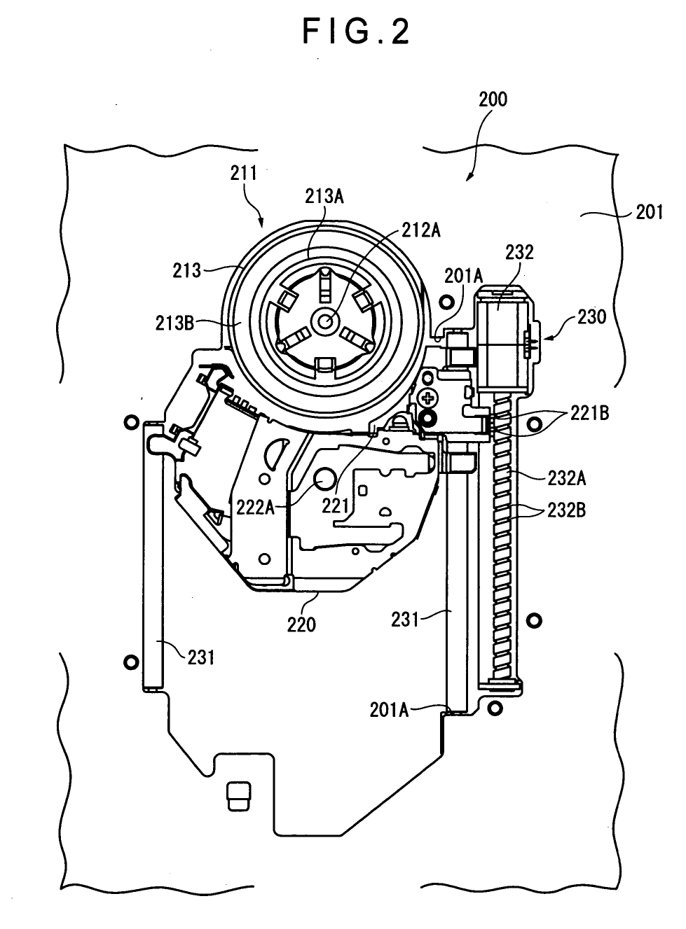

The disc processing section 200 has a pair of base portions (not shown) facing each other. The base portions are so provided in the case body as to be rotatable in the directions opposed to each other. Provided on the one base portion is a disc rotation drive section 211 constituting the drive section 210 together with a rotor (not shown) which is rotatably supported on the other base portion. The disc rotation drive section 211 includes a spindle motor 212 (shown in FIG. 1) provided on one base portion 201, and a turntable 213 (shown in FIG. 2) integrally provided with an output shaft 212A of the spindle motor 212. The spindle motor 212 is so connected to the system controller 300 as to be controllable by the controller 300 and driven by an electrical power supplied from the system controller 300. The turntable 213 includes a substantially column-shaped rotating shaft 213A serving as a shaft support portion which is inserted for fitting into a shaft hole (not shown) formed in the center of the optical disc 10 to rotatably support the optical disc 10 and a flange portion 213B which is projected from the outer circumferential surface around the rotating shaft 213A and on which the periphery of the shaft hole of the optical disc 10 is placed to support the optical disc 10. The rotation of the base portions in the opposite directions to each other allows the optical disc 10 to be held between the turntable 213 and a rotor (not shown) supported on the base portion different from that the turntable 213 is provided on. The optical disc 10 thus held is rotated together with the turntable 213 and rotor which are rotated by the drive of the spindle motor 212.

Further, provided on the base portion 201 is the moving section 230 which moves the optical pickup 220. The moving section 230 includes a pair of guide shafts 231 and a stepping motor 232. The pair of guide shafts 231 are, for example, elongated metal bars and arranged in substantially parallel to each other on the base portion 201. The stepping motor 232 is so connected to the system controller 300 as to be controllable by the controller 300 and driven by an electrical power supplied from the system controller 300. A lead screw 232A, which is, for example, an elongated metal bar, is concentrically and integrally connected to the output shaft (not shown) of the stepping motor 232. An engagement groove 232B is formed in a spiral manner on the outer circumferential surface of the lead screw 232A.

The optical pickup 220 is movably supported by the pair of guide shafts 231. The optical pickup 220 includes a holder 221 which is held between the pair of guide shafts 231 in a bridged manner. A movement regulating claw 221B to be engaged with the engagement groove 232B of the lead screw 232A of the moving section 230 is formed in the holder 221. The optical pickup 220 includes, in the holder 221, a light source (not shown), a plurality of optical elements (not shown) having an objective lens 222A which allows a light from the light source to irradiate on the optical disc 10, an optical sensor (not shown) which detects the light reflected by the optical disc 10, and the like. The optical pickup 220 is connected to the system controller 300, so that a signal can be exchanged between the two. Under the control of the system controller 300, the optical pickup 220 performs a process of reading various information recorded on the recording surface of the optical disc 10 so as to output the read information to the system controller 300 as well as a recording process of recording various information from the system controller 300 onto the recording surface.

(Configuration of System Controller)

A detailed configuration of the system controller will next be described with reference to the drawings.

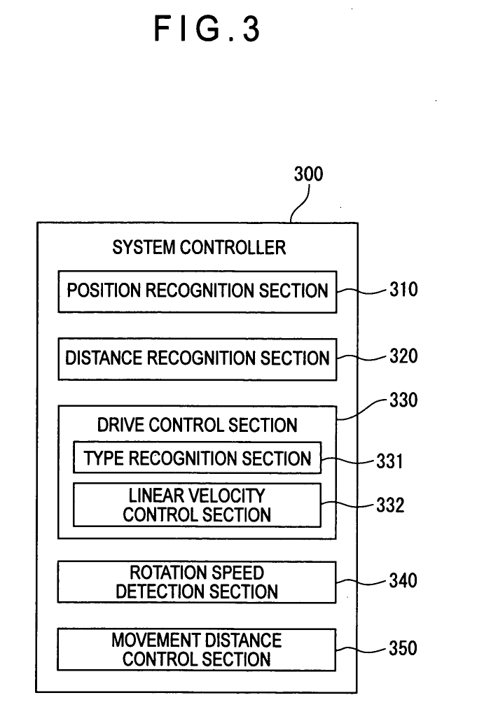

The system controller 300 is, as a circuit configuration, arranged on a circuit board which mounts various electrical components, for example. The system controller 300 includes, as shown in FIG. 3, programs such as a position recognition section 310, a distance recognition section 320 also serving as a distance calculation section, a drive control section 330, a rotation speed detection section 340, a movement distance control section 350, an internal counter (not shown), and the like.

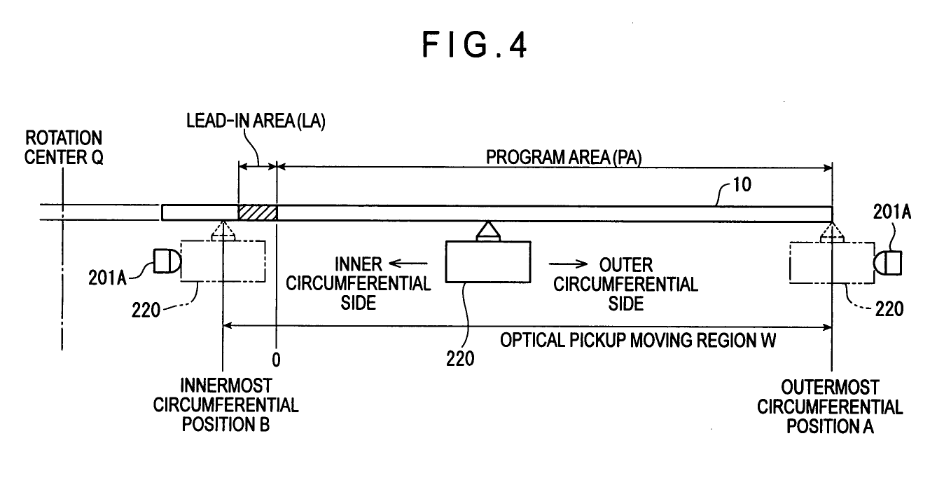

The position recognition section 310 recognizes the position of the optical pickup 220. The position recognition section 310 recognizes the position of the optical pickup 220 based on the count value of the not-shown internal counter. The position recognition section 310 also performs initialization processing to appropriately drive the stepping motor 232 serving as the moving section 230. The initialization processing is performed by causing a so-called loss of synchronism. In the initialization processing, as shown in FIG. 4, drive pulses of the same or slightly more than the pulse number required to move the optical pickup 220 over the entire movable range W between one-end sides and the other-end sides of the pair of guide shafts 231 are supplied to the stepping motor 232 to drive the same. When the drive pulses are thus supplied, the optical pickup 220 is moved to, for example, an innermost circumferential position B corresponding to the innermost circumference of the optical disc 10 to come into contact with the movement regulator 201A of the base portion 201. In the contact state, since the supply of the drive pulses to the lead screw 232A continues, and that results in a state of so-called loss of synchronism, where the lead screw 232A can no longer be rotated. Thereafter, the position recognition section 310 sets the count value of the not-shown internal counter to that indicating the innermost circumferential position B. The value of the internal counter is represented by, for example, integral values. The initialization of the count value of the internal counter makes the position of the optical pickup 220 corresponding to the count value of the internal counter. As a result, the position recognition section 310 can recognize the position of the optical pickup 220 based on the count value of the internal counter.

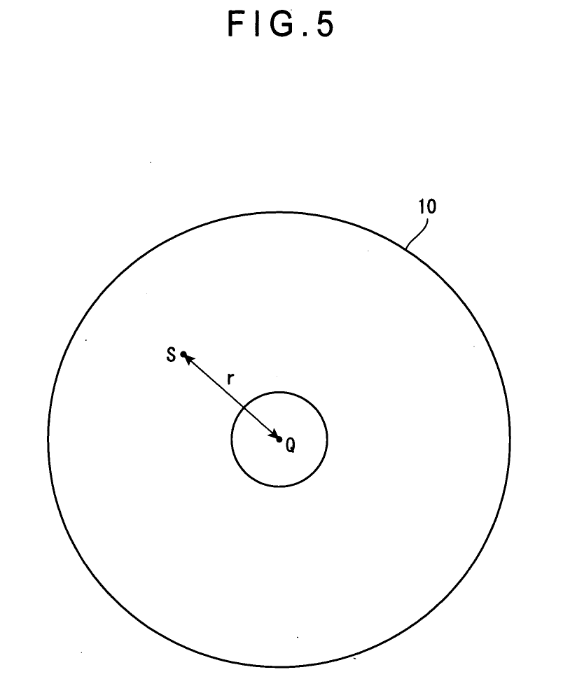

The distance recognition section 320 recognizes a state where the optical pickup 220 is moved by the moving section 230 to recognize the distance between the center Q of the optical disc 10 and the position at which the optical pickup 220 reads information. More specifically, the distance recognition section 320 recognizes the position of the optical pickup 220 based on the count value of the internal counter of the position recognition section 310. Based on the recognized position, the distance recognition section 320 recognizes the distance between the center Q of the optical disc 10 and the position on the recording surface of the optical disc 10 at which a light from the optical pickup 220 is focused, as exemplified by distance r [m] in FIG. 5.

The drive control section 330 controls the drive state of the spindle motor 212. In this control of the drive state, the drive control section 330 controls the rotation of the optical disc 10 so that the linear velocity of the optical disc 10 is constant, that is, the rotation speed of the optical disc 10 is constant at any position where the optical pickup 220 reads the information on the optical disc 10. The drive control section 330 includes a type recognition section 331, and a linear velocity control section 332 serving as a rotation speed control section.

The type recognition section 331 of the drive control section 330 recognizes the type of the optical disc 10. When, for example, the optical disc 10 is attached, the type recognition section 331 of the drive control section 330 controls the optical pickup 220 to focus a light on the recording surface of the optical disc 10 and determines the type of the optical disc 10 based on the light receiving state of the reflected light. When determining that the optical disc 10 is not an appropriate type, the type recognition section 331 drives the conveyance section to eject the optical disc 10. On the other hand, when determining that the optical disc 10 is a predetermined appropriate type, the type recognition section 331 stores the type in, for example, a memory (not shown). The information related to the type of the optical disc 10 stored in the memory is deleted when the optical disc 10 is ejected. The type recognition section 331 is not limited to the above configuration and it may use any other method to recognize the type of the optical disc 10.

The linear velocity control section 332 of the drive control section 330 controls the rotation speed of the output shaft 212A of the spindle motor 212 based on the count value of the internal counter corresponding to the position of the optical pickup 220 that the position recognition section 310 has recognized so that the rotation speed of the output shaft 212A becomes a predetermined linear velocity corresponding to the type of the optical disc 10 that the type recognition section 331 has recognized. In other words, the linear velocity control section 332 controls the rotation speed of the spindle motor 212 so that the optical pickup 220 can read a predetermined number of frames per unit time corresponding to the type of the optical disc 10, the number of address information which is format information, or the number of pits. In the case where the optical disc 10 is, for example, a CD-DA (Compact Disc-Digital Audio), the optical pickup 220 is controlled to read 75 [frames/sec].

The rotation speed detection section 340 detects the rotation speed of the optical disc 10, that is, the rotation speed N of the output shaft 212A of the spindle motor 212 by the drive control of the drive section 210. Various methods can be used to detect the rotation speed N [number of rotation/sec]. For example, it can be detected through a hall element (not shown) which controls the rotation drive state of the spindle motor 212, or by recognizing current waveform (for example, phase-change state) for rotating/driving the spindle motor 212.

The movement distance control section 350 calculates linear velocity L [m/s] at any position S on the optical disc 10, as shown in FIG. 5, where the optical pickup 220 performs reading operation based on the rotation speed N detected by the rotation speed detection section 340 and the distance r recognized by the distance recognition section 320. More specifically, the calculation is performed based on the relational expression: L=2πrN. When the optical disc 10 is rotated at a speed n-times as fast as the normal speed (so called n-fold speed), this relational expression of the linear velocity becomes: L=2πrN/n. The movement distance control section 350 recognizes the characteristics of the optical disc 10 the information on which has been read by the optical pickup 220, that is, the specific linear velocity of the optical disc 10 (for example, the linear velocity obtained at the time when music information or image information is recorded, or the linear velocity at the time when the disc is preformatted). The recognized specific linear velocity of the optical disc 10 is stored in, for example, a memory (not shown). The specific linear velocity of the optical disc 10 stored in the memory is deleted when, for example, the optical disc 10 is ejected.

Further, the movement distance control section 350 calculates the distance between a predetermined position corresponding to the predetermined information recorded on the optical disc 10 and the center Q thereof based on the linear velocity obtained by the above expression: L=2πrN. That is, the recognition of the specific linear velocity of the optical disc 10 based on the above expression allows the distance between a predetermined position at which predetermined information is processed and the center of the optical disc 10 to be relatively calculated, because the information is processed with the linear velocity in a relative way. For example, when the optical pickup 220 is moved to a predetermined position by the moving section 230, the movement distance control section 350 calculates, in a relative manner, the distance between the position at which the predetermined information is recorded and the center Q of the optical disc 10 based on content information such as a TOC (Table Of Contents) or the like recorded in a program area. The movement distance control section 350 moves the moving section 230 based on the calculated distance. That is, the movement distance control section 350 performs the control so that the value of the internal counter becomes a predetermined value.

[Operation of Disc Unit]

An operation of the disc unit 100 in the first embodiment will next be described.

Upon supply of power to the electrical apparatus, power is applied to the disc unit 100. The system controller 300, which starts operating by receiving the power, performs the initialization processing (normalization of the optical pickup 220) to recognize the position of the optical pickup 220. That is, the position recognition section 310 of the system controller 300 allows drive pulses of the same or slightly more than the pulse number required to move the optical pickup 220 toward the innermost circumferential position B within the entire movable range W to be supplied to the stepping motor 232 of the moving section 230. As a result, a loss of synchronism of the stepping motor 232 occurs. In this state, the position recognition section 310 sets the count value of the internal counter to that indicating the innermost circumferential position B.

Thereafter, the system controller 300 determines whether the optical disc 10 has been attached or not. The system controller 300 determines the presence/absence of the optical disc 10 through the detection operation of the optical disc 10 using a disc detection section such as separately provided not-shown sensor or switch or the detection operation of the optical disc 10 in which the optical pickup 220 is controlled to detect the presence/absence of the emitted light reflected by the optical disc 10. When determining that the optical disc 10 has not been attached, the system controller 300 continues waiting for the attachment of the optical disc 10. On the other hand, when determining that the optical disc 10 has been attached, the system controller 300 allows the optical pickup 220 to read out information in a lead-in area of the attached optical disc 10 to recognize recording state or recoding contents and allows a display unit (not shown) provided in the disc unit 100 to appropriately display the recording state or recoding contents.

When determining the presence/absence of the optical disc 10 based on the light receiving state of the emitted light reflected by the optical disc 10 obtained as a result of focus search performed by the optical pickup 220, the system controller 300 allows the type recognition section 331 of the drive control section 330 to recognize the type of the optical disc 10 as well as allows the linear velocity control section 332 to control the linear velocity to a constant value at which the optical pickup 220 can read the number of frames per unit time corresponding the types of the optical disc 10 or the number of access information. For example, in the case of a CD, it rotates at 75 [frames/sec]. During the constant linear velocity control, the system controller 300 allows the distance recognition section 320 to recognize the distance r between the information reading position and the center Q of the optical disc 10, allows the rotation speed detection section 340 to recognize the rotation speed N, and allows the movement distance control section 350 to recognize the specific linear velocity L of the optical disc 10 based on the above-mentioned relational expression. The system controller 300 then determines that the optical disc 10 has been attached and, at the same time, recognizes the type of the optical disc 10 and appropriately stores it in the memory together with the specific linear velocity. The time when the processing of recognizing the specific linear velocity L is performed is not limited to the time when the presence/absence of the optical disc 10 is determined. In the case where the presence/absence of the optical disc 10 is determined using, for example, a sensor, the processing of recognizing the specific linear velocity L may be performed during the processing of determining the type of the optical disc 10.

When the system controller 300 detects that the optical disc 10 has been attached in its waiting state for the attachment of the optical disc 10, that is, when a not-shown sensor or detection switch has detected that a part of the optical disc 10 has been inserted into the opening portion, the system controller 300 allows the conveyance section to start operating. For example, the conveyance section rotates a not-shown roller to convey the optical disc 10 toward the inside of the case body, up to the position where the disc processing section 200 can apply predetermined processing thereto. When the optical disc 10 is conveyed to the predetermined position, the pair of base portions 201 are rotated in the opposite directions to each other to clamp the optical disc 10, that is, to hold the optical disc between the turntable 213 and rotor. As a result, the system controller 300 recognizes the attachment of the optical disc 10. Thereafter, as described above, the system controller 300 recognizes the type of the optical disc 10 by the type recognition section 331 and, at the same time, recognizes the distance r and rotational number N to thereby recognizing the specific linear velocity of the optical disc 10.

After recognizing the specific linear velocity L of the optical disc 10, the system controller 300 controls the operation of the moving section 230 to allow the optical pickup 220 to read out information in lead-in area of the optical disc 10. The system controller 300 then recognizes recording state or recording contents based on the read out information and appropriately displays it. When a user performs an input operation through a not-shown operating section provided in the disc unit 100 with reference to the displayed contents, the system controller 300 recognizes a signal corresponding to the user's input operation and allows the disc processing section 200 to operate to thereby appropriately perform information processing to read out the recorded information from the optical disc 10 or record information onto the optical disc 10.

During the information processing, the movement distance control section 350 of the system controller 300 recognizes the position of the program area at which the information to be processed is recorded or the position of the program area at which information is to be recoded based on the contents information described in the lead-in area and the like. Then, when the movement distance control section 350 recognizes the position on the optical disc 10 at which information processing is performed, it recognizes the distance between the recognized position and the center Q. Thereafter, the movement distance control section 350 uses the specific linear velocity L of the attached optical disc 10 to calculate the distance in a relative way.

The system controller 300 then controls the drive of the moving section 230 based on the calculated distance, that is, allows the moving section 230 to supply the stepping motor 232 with a drive pulse so that the count value of the internal counter indicates the position corresponding to the calculated distance to move the optical pickup 220. As a result, the optical pickup 220 is adequately moved to a target position in accordance with the specific linear velocity L of the optical disc 10.

[Working and Effect of Embodiment]

As described above, in the above embodiment, the linear velocity control section 332 of the drive control section 330 allows the optical pickup 220 to read the frame information, address information of the program or pits recorded at an arbitrary position S on the optical disc 10. Based on the above information and the like, the drive of the spindle motor 212 of the drive section 210 is controlled to rotate the optical disc 10 at a predetermined linear velocity (in the case of CD, for example, 75 [frames/sec]) corresponding to the type of the optical disc 10. The rotation speed N of the optical disc 10 during the constant linear velocity control is detected by the rotation speed detection section 340 and, at the same time, the distance r between the position S of the information that the optical pickup 220 is reading based on the count value of the internal counter indicating the position on the optical disc 10 and the center Q is recognized by the distance recognition section 320. Based on the recognized distance r and rotation speed N, the specific linear velocity L of the optical disc 10 is calculated by the movement distance control section 350. The predetermined position at which information processing is performed in response to a request for information processing is recognized based on contents information, and the distance between the actual predetermined position and the center Q is recognized using the calculated linear velocity L. That is, the specific linear velocity L of the optical disc 10 is recognized based on the distance r and rotation speed N, and the recognized linear velocity L is used to calculate the actual predetermined position at which information processing is performed in a relative way. The drive of the moving section 230 is then controlled based on the calculated distance to move the optical pickup 220 to the predetermined position at which information processing is performed. As a result, at the time when information processing is performed, the optical pickup 220 can be moved to an adequate position with simple calculations in accordance with the specific linear velocity L of the optical disc 10, thereby reducing the time to start information processing and resulting in speedy information processing. Further, at the time when the presence/absence, type, or the like of the optical disc 10 is determined, the processing for recognizing the specific linear velocity L of the optical disc 10 need not be separately performed but can be performed in parallel with the other processing, thereby reducing the time to start information processing. As a result, speedy information processing can be achieved and usability can be increased.

The specific linear velocity L is recognized based on the rotation speed N and distance r between the center Q and an arbitrary position S, and the recognized linear velocity L is used to calculate the distance between the actual predetermined position of the information to be processed and the center Q in a relative way. Therefore, with simple calculations, it is possible to easily and adequately recognize a predetermined position of the information to be processed, thereby adequately realizing speedy information processing.

By using the linear velocity L, the distance r between an arbitrary position S and the center Q, and rotation speed N, the distance between a predetermined position and the center Q of the optical disc 10 is calculated in a relative way. Therefore, it is possible to easily recognize the information density of the optical disc 10 and thereby to easily and adequately recognize a predetermined position at which information processing is actually performed based on simple calculations.

Further, the stepping motor 232 is used as the moving section 230 for moving the optical pickup 220 to control the movement of the optical pickup 220 by the count value of the internal counter. Therefore, it is possible to accurately recognize the position of the optical pickup 220 and distance r up to an arbitrary position S, making it easy to more adequately recognize a predetermined position.

The drive of the spindle motor 212 is controlled so that the linear velocity of the optical disc 10 becomes constant, that is, the number of frames, address information, and pits counted in one second which is unit of time become constant. Therefore, it is possible to easily recognize the distance r up to an arbitrary position S and rotation speed N. This makes it easy to recognize the specific linear velocity L of the optical disc 10 used for performing speedy and adequate information processing.

Further, the determination of the type of the optical disc 10, which is performed in order for the constant linear velocity control to correspond to the type of the optical disc 10, is made based on the light receiving state of the light reflected by the optical disc 10 obtained as a result of focus search performed by the optical pickup 220. Therefore, at the time when the type of the optical disc 10 is recognized, the distance r up to the current position S and the rotation speed N can easily be recognized, making it easy to realize speedy information processing.

Further, when the attachment of the optical disc 10 is recognized, the distance r up to an arbitrary position S and the rotation speed N are recognized in order to obtain the specific linear velocity L of the optical disc 10 at an arbitrary position S. That is, when the optical disc 10 has been attached, the processing for recognizing the specific linear velocity L of the optical disc 10 is performed while the optical pickup 220 is operated in order to determine the type of the optical disc 10. Therefore, at the time when information processing is performed after attachment of the optical disc 10, it is possible to quickly and adequately move the optical pickup 220 to a predetermined position at which information processing is performed, making it easy to realize speedy information processing as described above.

The above configuration is applied to the disc unit 100 to which the optical disc 10 is detachably attached. Therefore, when a different type of the optical disc 10 has been attached, the optical pickup 220 can quickly and adequately be moved in accordance with the specific linear velocity of the attached optical disc 10 to a predetermined position at which information processing is performed. In particular, it is advantageous that the distance r and rotation speed N can be obtained when the different type of the optical disc 10 has been attached since the constant linear velocity control is performed depending on the type of the optical disc 10.

Further, the system controller 300 including various programs is adopted as a circuit configuration. Therefore, it is possible to easily obtain the abovementioned configuration simply by loading programs, thereby increasing manufacturability. Further, it is possible to load the programs into the conventional disc unit to obtain the configuration according to the present invention, easily increasing versatility.

[Modification]

The present invention is not limited to the above embodiment but can be modified without departing from the scope of the invention as follows.

In the above embodiment, the disc unit 100 uses the disc recording medium. As described above, the disc unit 100 can use any disc recording medium including a magnetic disc, a magneto optical disc, and the like, in addition to the optical disc 10. Further, the present invention can be applied to the disc unit 100 that performs only one of reading and recording operations. Further, any configuration including so-called a slim drive, slot in type, tray type having a tray, and the like can be employed as the disc unit 100. The configuration of the information processing section is not limited to the pick-up mechanism for the disc recording medium, that is, a mechanism using a light, but any configuration such as a magnetic head can be used.

As the moving section 230 that moves the optical pickup 220, any motor such as a DC motor can be used in addition to the stepping motor 232. Further, any configuration such as one in which the optical pickup 220 is moved along with the rotation of an endless belt or one which utilizes a linear motor can be used.

As the initialization processing, which is a normalization method for recognizing the position of the optical pickup 220, the configuration allowing so-called the loss of synchronism to occur is used. Alternatively, however, any method can be used for detecting the position of the optical pickup 220. For example, a method that uses a sensor or switch to detect that the optical pickup 220 has been set to the innermost circumferential position B, stops the optical pickup 220 at that position based on specific address information, and recognizes the position of the optical pickup 220 with the stop position as a reference can be adopted.

In the above embodiment, the specific linear velocity L of the optical disc 10 at an arbitrary position S is recognized based on a predetermined relational expression, and the distance between a predetermined position of the information to be processed and the center Q is calculated with relative ratio based on the specific linear velocity L. Alternatively, however, a configuration may be employed in which the inner circumferential area from an arbitrary position S is calculated based on the distance r and rotation speed N at the position S, and the distance up to a predetermined position at which information processing is performed is calculated in a relative way based on the calculated area.

Although each of the components included in the system controller 300, such as a position recognition section 310, distance recognition section 320 also serving as the distance calculation section, drive control section 330, rotation speed detection section 340, movement distance control section 350, and not-shown internal counter is constituted as a program in the above embodiment, they may be configured as a circuit or circuit element. Further, the configuration of the system controller 300 is not limited to that including the above components. For example, a configuration is allowable in which a section for recognizing the specific linear velocity L of the optical disc 10 at an arbitrary position S with any method is provided, and a predetermined position at which information processing is performed is recognized based on the linear velocity L in a relative way. Further, the system controller 300 can be distributed as an information processing device configured as a circuit configuration, a program allowing the abovementioned operations to be performed, or a recording medium that stores the program.

Although the specific linear velocity L is recognized at the time when the optical disc 10 has been attached in the above embodiment, the specific linear velocity L may be recognized at any timing. For example, the specific linear velocity L may be recognized while the optical pickup 220 is moved based on a request for information processing and the information processing is performed. In this configuration, once the specific linear velocity L is recognized, the optical pickup 220 can adequately be moved to a predetermined position at which information processing is performed as in the case of the configuration described above. Further, this configuration can reduce the time between the attachment of the optical disc 10 and start of information reproduction. Once the specific linear velocity L is recognized, the optical pickup 220 can adequately be moved to a predetermined position as described above, so that it is preferable that the specific linear velocity L be calculated in the early stage.

Although CD-DA is taken as a concrete example, a disc recording medium that can be used in the present invention is not limited to one which previously stores contents and the like, but any recording medium including unused and rewritable one in which contents has not been recorded, one in which only preformat information has been recorded, one in which contents has been recorded partly, and the like can be used. Examples of such disc recording medium include DVD-R (Digital Versatile Disc Recordable), DVD-RW (Digital Versatile Disc Rewritable), CD-RAM (Compact Disc Random Access Memory) and the like. The linear velocity control may appropriately be performed based on the number of frames, the number of address information, and the number of pits corresponding to the type of the disc.

The concrete structure and procedure of the present invention in practical use may be modified into another structure and the like without departing from the spirit and scope of the present invention.

[Advantage of Embodiment]

As described above, the drive of the spindle motor 212 of the drive section 210 is controlled to rotate the optical disc 10 at a predetermined linear velocity (in the case of CD, for example, 75 [frames/sec]) corresponding to the type of the optical disc 10 based on the frame information, address information of the program or pits recorded at an arbitrary position S on the optical disc 10 that the optical pickup 220 has read. With the drive control, the rotation speed N of the optical disc 10 is detected and, at the same time, the position of the optical pickup 220 is recognized to recognize the distance r between the position S of the information that the optical pickup 220 is reading and the center Q. Based on the recognized distance r and rotation speed N, the specific linear velocity L of the optical disc 10 is calculated. The distance between a predetermined position of the information to be processed and the center Q is calculated based on the obtained linear velocity L. After that, the drive of the moving section 230 is controlled to move the optical pickup 220 to the predetermined position at which information processing is performed. As a result, at the time when information processing is performed, the optical pickup 220 can be moved to an adequate position with simple calculations in accordance with the specific linear velocity L of the optical disc 10. For example, at the time when the presence/absence, type, or the like of the optical disc 10 is determined, the processing for recognizing the specific linear velocity L of the optical disc 10 need not be separately performed but can be performed in parallel with the other processing, thereby reducing the time to start information processing. As a result, speedy information processing can be achieved.

The priority application Number JP 2004-099972 upon which this patent application is based is hereby incorporated by reference.

1. An information processing device that allows a drive section to rotate a disc recording medium and allows an information processing section which is moved, by a moving section, along the recording surface of the disc recording medium in the radial direction thereof to perform at least one of a process of reading information recorded on the disc recording medium and a process of recording the information onto the disc recording medium, comprising:
a drive control section that controls the drive section at linear velocity corresponding to the type of the disc recording medium to allow the information processing section to read information recorded at an arbitrary position on the disc recording medium;
a rotation speed detection section that detects the rotation speed of the disc recording medium at the time when the drive section is controlled at a constant linear velocity by the drive control section;
a distance recognition section that recognizes the position of the information processing section and thereby recognizes the distance between the center of the disc recording medium and the position at which the information processing section reads the information; and
a movement distance control section that calculates the linear velocity of the disc recording medium based on the rotation speed and the distance, calculates the distance between a predetermined position of the information to be processed on the disc recording medium and the center thereof based on the linear velocity, and controls the moving section based on the calculated distance to move the information processing section to the predetermined position.

2. The information processing device according to claim 1, wherein
the movement distance control section calculates the linear velocity of the disc recording medium based on the following relational expression:
L=2πrN
where L is the linear velocity, r is the distance up to the position at which the information processing section reads the information, and N is the rotation speed.

3. The information processing device according to claim 1, wherein
the moving section includes a stepping motor to move the information processing section, and
the distance recognition section includes an internal counter which counts in accordance with the movement distance from a reference position of the information processing section, and a distance calculation section that calculates, based on a count value of the internal counter, the distance between the center of the disc recording medium and the position on the disc recording medium at which the information processing section performs information processing.

4. The information processing device according to claim 1, wherein
the drive control section includes a type recognition section that recognizes the type of the disc recording medium and a rotation speed control section that rotates the drive section to allow the information processing section to read at least one of the number of frames and preformat information per unit time on the disc recording medium, both the information corresponding to the recognized type.

5. The information processing device according to claim 4, wherein
the information processing section is an optical pickup, and
the type recognition section recognizes the type of the disc recording medium based on the state of the light emitted to the disc recording medium and reflected therefrom.

6. The information processing device according to claim 1, wherein
the drive control section allows the information processing section to read information described in a lead-in area of the disc recording medium.

7. The information processing device according to claim 1, wherein
based on the information described in a read-in area of the disc recording medium, the movement distance control section relatively calculates, based on the relative positional relationship between the information recorded at the arbitrary position on the disc recording medium and the predetermined information, the predetermined distance of the position of the predetermined information from the distance recognized by the distance recognition section and the linear velocity at that position.

8. The information processing device according to claim 1, wherein
when it is recognized that the disc recording medium is mounted, the drive control section allows the information processing section to read the information at an arbitrary position on the disc recording medium and thereby performs a constant linear velocity control.

9. A disc unit comprising:
a drive section that rotates a disc recording medium;
an information processing section that performs at least one of a process of reading information recorded on the disc recording medium and a process of recording the information onto the disc recording medium;
a moving section that moves the information processing section along the recording surface of the disc recording medium in the radial direction thereof;
a drive control section that controls the drive section at linear velocity corresponding to the type of the disc recording medium to allow the information processing section to read information recorded at an arbitrary position on the disc recording medium;
a rotation speed detection section that detects the rotation speed of the disc recording medium at the time when the drive section is controlled at a constant linear velocity by the drive control section;
a distance recognition section that recognizes the position of the information processing section and thereby recognizes the distance between the center of the disc recording medium and the position at which the information processing section reads the information; and
a movement distance control section that calculates the linear velocity of the disc recording medium based on the rotation speed and the distance, calculates the distance between a predetermined position of the information to be processed on the disc recording medium and the center thereof based on the linear velocity, and controls the moving section based on the calculated distance to move the information processing section to the predetermined position.

10. A disc unit comprising:
a drive section that rotates a disc recording medium at a constant linear velocity;
an information processing section that performs at least one of a process of reading information recorded on the disc recording medium and a process of recording the information onto the disc recording medium;
a moving section that moves the information processing section along the recording surface of the disc recording medium in the radial direction thereof; and
a controller that detects the distance between the information that the information processing section reads on the disc recording medium and the center thereof and the rotation speed of the disc recording medium to thereby calculate the linear velocity of the disc recording medium, and calculates, based on the calculated linear velocity, the distance between a predetermined information on the disc recording medium and the center thereof to thereby control the moving section to move the information processing section.

11. An information processing method that rotates a disc recording medium and moves an information processing section along the recording surface of the disc recording medium in the radial direction thereof to thereby perform at least one of a process of reading information recorded on the disc recording medium and a process of recording the information onto the disc recording medium, comprising the steps of:
allowing the information processing section to read information described at an arbitrary position on the disc recording medium to rotate the disc recording medium at a constant linear velocity;
recognizing the rotation speed of the disc recording medium at the time of the constant linear velocity control and the distance between the position at which the information processing section reads the information and the center of the disc recording medium;
calculating the linear velocity of the disc recording medium at the position where the information processing section is reading the information based on the recognized rotation speed and the distance;
recognizing a predetermined position of the information to be processed on the disc recording medium in response to a request for the information processing and recognizing the distance between the predetermined position on the disc recording medium and the center thereof based on the calculated linear velocity; and
moving the information processing section to the predetermined position based on the recognized distance.

12. An information processing method that rotates a disc recording medium and moves an information processing section along the recording surface of the disc recording medium in the radial direction thereof to thereby perform at least one of a process of reading information recorded on the disc recording medium and a process of recording the information onto the disc recording medium, comprising the steps of:
controlling the drive section at linear velocity corresponding to the type of the disc recording medium to allow the information processing section to read information recorded at an arbitrary position on the disc recording medium;
detecting the rotation speed of the disc recording medium at the time when the drive section is controlled at a constant linear velocity and recognizing, based on the position of the information processing section, the distance between the center of the disc recording medium and the position at which the information processing section reads the information;
calculating, based on the rotation speed and the distance, the linear velocity of the disc recording medium at the position where the information processing section reads the information;
calculating, based on the calculated linear velocity, the distance between a predetermined position of the information to be processed on the disc recording medium and the center thereof; and
controlling the moving section, based on the calculated distance, to move the information processing section to the predetermined position.

13. A recording medium on which an information processing program is recorded in a computer readable manner, the information processing program allowing a computer to function as an information processing device that allows a drive section to rotate a disc recording medium and that allows an information processing section which is moved, by a moving section, along the recording surface of the disc recording medium in the radial direction thereof to perform at least one of a process of reading information recorded on the disc recording medium and a process of recording the information onto the disc recording medium, wherein
the information processing device includes functions as:
a drive control section that controls the drive section at linear velocity corresponding to the type of the disc recording medium to allow the information processing section to read information recorded at an arbitrary position on the disc recording medium;
a rotation speed detection section that detects the rotation speed of the disc recording medium at the time when the drive section is controlled at a constant linear velocity by the drive control section;
a distance recognition section that recognizes the position of the information processing section and thereby recognizes the distance between the center of the disc recording medium and the position at which the information processing section reads the information; and
a movement distance control section that calculates the linear velocity of the disc recording medium based on the rotation speed and the distance, calculates the distance between a predetermined position of the information to be processed on the disc recording medium and the center thereof based on the linear velocity, and controls the moving section based on the calculated distance to move the information processing section to the predetermined position.

14. A recording medium on which an information processing program is recorded in a computer readable manner, the information processing program rotating a disc recording medium and moving an information processing section along the recording surface of the disc recording medium in the radial direction thereof to thereby perform at least one of a process of reading information recorded on the disc recording medium and a process of recording the information onto the disc recording medium, allowing a computer to execute the steps of:
controlling the drive section at linear velocity corresponding to the type of the disc recording medium to allow the information processing section to read information recorded at an arbitrary position on the disc recording medium;
detecting the rotation speed of the disc recording medium at the time when the drive section is controlled at a constant linear velocity and recognizing, based on the position of the information processing section, the distance between the center of the disc recording medium and the position at which the information processing section reads the information;
calculating, based on the rotation speed and the distance, the linear velocity of the disc recording medium at the position where the information processing section reads the information;
calculating, based on the calculated linear velocity, the distance between a predetermined position of the information to be processed on the disc recording medium and the center thereof; and
controlling the moving section based on the calculated distance to move the information processing section to the predetermined position.
